(19) United States
(12) Patent Application Publication
(10) Pub. No.: US 2020/0201377 A1
(43) Pub. Date: Jun. 25, 2020

(54) ADJUSTMENT KNOB HAVING POSITIONAL MEMORY

(71) Applicant: Chemistry Design Werks, LLC, Saint Paul, MN (US)

(72) Inventor: Christian Trifilio, Saint Paul, MN (US)

(21) Appl. No.: 16/643,574

(22) PCT Filed: Aug. 27, 2018
(86) PCT No.: PCT/US18/48143

§ 371 Date: Mar. 1, 2020

Related U.S. Application Data
(60) Provisional application No. 62/553,352, filed on Sep. 1, 2017.

(51) Int. Cl. G05G 1/015; G05G 1/10; H01H 3/08; H01H 9/18

(52) U.S. Cl. CPC G05G 1/015; G05G 1/10; G10H 1/0008; H01H 9/18; H01H 3/08

(57) ABSTRACT

An adjustment knob comprising a marker disk and a knob body is disclosed. The marker disk, comprised of a disk material, has a slot shaped opening and the knob body, comprised of a resilient material, has a first end and a second end. The first end is configured to reversibly secure the knob body to an adjustment shaft. The second end has a receptacle configured to securely receive the marker disk such that the marker disk can be rotated relative to the knob body.

### PRIORITY CLAIMS

This application claims the benefit of International Application No. PCT/US2018/048143 filed Aug. 27, 2018, which claims the benefit of U.S. Provisional Application No. 62/553,352 filed Sep. 1, 2017, the entireties of which applications are hereby incorporated by reference into this application.

### FIELD OF THE DISCLOSURE

The present disclosure relates in general to adjustment knobs for devices and their method of use, and more particularly, relates to adjustment knobs with features that assist a user in marking or remembering as well as efficiently restoring device settings, for example, including but not limited to sound effects processing devices such as guitar effects pedals, amplifiers, and like devices.

### BACKGROUND

When playing and recording music, musicians and producers often use effects units and other devices to alter the sound of a musical instrument or other sound source. Some effects units are built into an instrument while others are separate from the instrument. For example, guitar players will often use separate effects pedals to alter the sound of their electric guitars in addition to their amplifier settings, while producers may use rack units and other auxiliary sound-processing and simulating devices in a studio setting.

All of these devices often include one or more rotary adjustment knobs controlling different parameters that can allow the user to modify and custom-tailor the applied effect and resulting sound. Due to the numerous parameters that can be adjusted, including for example overdrive, distortion, compression, reverb, delay, as well as the volume, intensity, time or degree of each parameter, a high degree of creative experimentation is possible and encouraged by these devices. However, with so many parameters, it can take significant time and effort to adjust each and every knob until the desired sound and effect is achieved, thus musicians are often hesitant to engage in further experimentation for fear of losing their previous setting combinations. This problem is only exacerbated when multiple knobs are involved, as the number of possible settings combinations increases multiplicatively with each additional knob and corresponding parameter. Consequently, many musicians end up physically marking the device itself adjacent to the knobs, using a marker or piece of tape, which is not only cumbersome but also distracts from the aesthetic of these devices and in some cases can damage the original markings or graphics.

Further, aside from the field of music, there are other examples of equipment and devices utilizing numerous control and adjustment knobs, and where similar problems can be encountered in marking and restoring combinations of knob settings. Commonly potentiometers, informally known as “pots,” are designed with an adjustment shaft having a nut at the base of the shaft. After manufacture of a device having potentiometers, during assembly a knob body is then typically secured onto the potentiometer shafts via press fit or using a lateral locking screw, for example. Although there are numerous examples of knob bodies available, including those having structural features for locking the knobs into fixed positions such as described in U.S. Pat. No. 3,855,877 by Gach or U.S. Pat. No. 3,995,201 by Allardice, Jr., or additional features for adjusting the drag on knobs to change their feel and control accuracy such as described in U.S. Pat. No. 4,154,125 by Frank or U.S. Pat. No. 4,347,758 by Geil et al., none of these devices provide a means for efficiently storing a desired position of the knob(s) and restoring the desired position after further use.

Potentiometer-type controls are used in a plethora of devices and industries, thus it would be desirable to provide a knob having improved features to allow users to easily mark one or more desired knob settings and efficiently return to a marked configuration of settings after making further knob adjustments.

### SUMMARY OF THE INVENTION

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure relates to adjustment knobs with features that assist users in marking or storing and then restoring knob positions. In an illustrative but non-limiting example, the disclosure provides an adjustment knob that can include a marker disk and a knob body. The marker disk, comprised of a disk material, has a slot shaped opening, and the knob body, comprised of a resilient material, can include a first end and a second end, the first end being structured and configured to reversibly secure the knob to an adjustment shaft, the second end defining a receptacle structured and configured to securely receive the marker disk such that the marker disk can be rotated relative to the knob body.

In some examples, the marker disk can be retained by the knob body by an interference fit, and friction between the marker disk and the knob body can allow the marker disk to be rotated relative to the knob body via external torque applied to the marker disk when the knob body is rotationally constrained.

In some examples, friction between the marker disk and the knob body can prevent rotation of the marker disk relative to the knob body when the knob body is rotated in the absence of external torque applied to the marker disk.

In another illustrative but non-limiting example, the disclosure provides a method for using the knob by securing it to the adjustment shaft of a device, rotating the knob to a desired position, and applying an external torque to the marker disk to rotate it relative to the knob body to store the desired position via an orientation of the marker disk.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in connection with the accompanying drawings, in which:

FIG. 1 is a schematic exploded perspective view of a knob of the present disclosure that can include a knob body and a marker disk;

FIG. 2 is a schematic perspective view of the knob in an assembled state, with the marker disk nested in position in the knob body;

FIG. 3 is a schematic perspective view showing the bottom side of the knob;

FIG. 4 is a schematic bottom plan view of the knob body of the knob;

FIG. 5 is a schematic top plan view of the knob body of the knob without the marker disk;

FIGS. 6 and 7 are schematic elevation views of different sides of the knob;

FIG. 8 is a cross-sectional view of the knob along section A-A of FIG. 4;

FIGS. 9A and 9B are schematic illustrations of a user adjusting the marker disk of the knob with the knob attached to an effects pedal; and

FIG. 10 is a schematic illustration of an effects pedal with a plurality of knobs of the present disclosure, with the knobs being rotated from a modified state (shown on the left) and then restored to a previously-marked desired state (shown on the right).

### DETAILED DESCRIPTION

Disclosed herein is an improved adjustment knob and method of use, enabling a user to store a desired setting (i.e. position) for one or more knobs secured to a device, make further adjustments to those knobs, and then efficiently restore the one or more knobs back to their original desired setting(s). Various embodiments are described in detail with reference to the drawings, in which like reference numerals may be used to represent like parts and assemblies throughout the several views. Reference to various embodiments does not limit the scope of the systems and methods disclosed herein. Examples of construction, dimensions, and materials may be illustrated for the various elements; those skilled in the art will recognize that many of the examples provided have suitable alternatives that may be utilized. Any examples set forth in this specification are not intended to be limiting and merely set forth some of the many possible embodiments for the systems and methods. It is understood that various omissions and substitutions of equivalents are contemplated as circumstances may suggest or render expedient, but these are intended to cover applications or embodiments without departing from the spirit or scope of the disclosure. Also, it is to be understood that the phraseology and terminology used herein are for the purpose of description and should not be regarded as limiting.

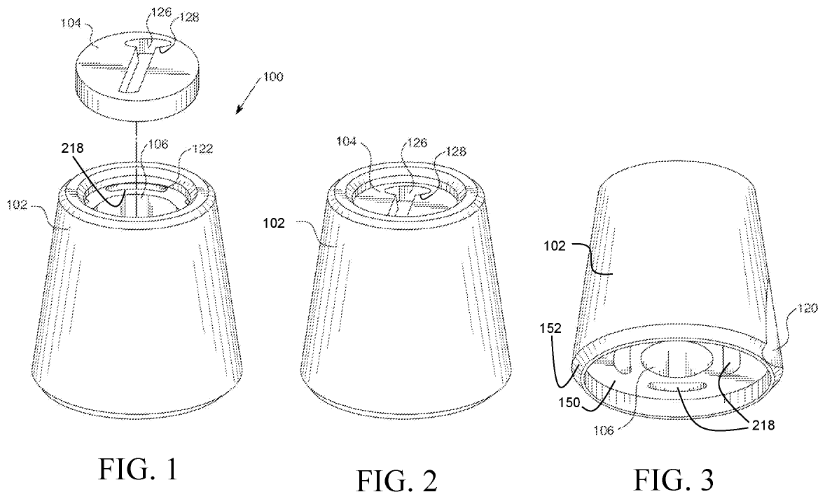

FIG. 1 is a schematic exploded perspective view of a knob 100, showing knob body 102, marker disk 104, central opening 106, receptacle 122, slot shaped opening 126, and disk orientation indicator 128. FIG. 2 is a schematic perspective view of knob 100 in an assembled state, with marker disk 104 nested in position in receptacle 122 of knob body 102. FIGS. 1 and 2 are illustrated to show the top side of knob 100 as the knob might be viewed by a user. FIG. 3 is a schematic perspective view of knob 100 showing the bottom side of the knob, and further showing knob position indicator 120, satellite openings 218, as well as recessed surface 150 and flange 152.

Knob body 102 can define or include an opening 106 at a bottom side or end that can be sized and configured to reversibly secure the knob body to the shaft of a potentiometer or any other suitable rotationally-adjustable device, such as an effects pedal. Opening 106 can be a through-opening, from the bottom to the top of knob body 102 (as shown in more detail, for example, with reference to FIG. 8). Central opening 106 can have any suitable shape, though in most configurations will be circular as depicted to accommodate the most common cylindrical shape of shafts to which knob 100 will be attached. When knob 100 is secured to an adjustment shaft of a potentiometer or pot, for example, the recessed surface 150 can be seated on the nut portion at the base of the shaft while flange 152 functions to hide the nut from view, thereby creating a more aesthetically pleasing appearance of knob 100 in use. Further, flange 152 can be beveled as shown to ensure that any markings adjacent to knob 100 on a device are not obscured.

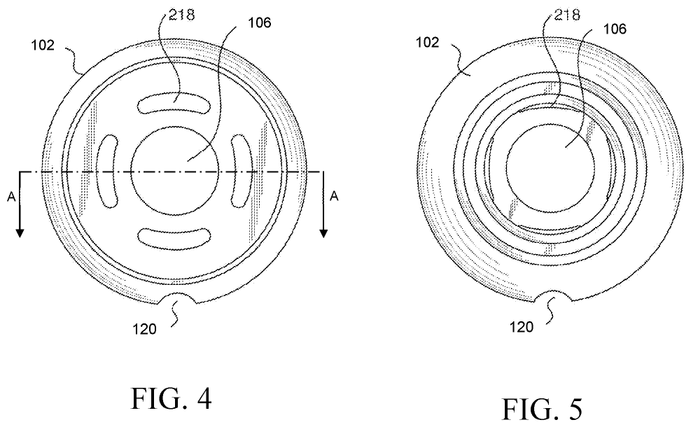

FIG. 4 is a schematic bottom plan view of knob body 102, and FIG. 5 is a schematic top plan view, showing substantially circular or round central opening 106 and satellite openings or voids 218 circumferentially spaced around central opening 106. Central opening 106 can include a central portion 108 (shown with reference to FIG. 8) that is sized and configured to accommodate a generally cylindrical shaft, whether in split or solid form and having varying diameters.

In one example, central portion 108 may have a diameter smaller than a diameter of an adjustment shaft of a potentiometer when knob body 102 is in an unmounted state. However, the resiliency of the material of knob body 102, in combination with the features of central opening 106 in proximity to circumferentially spaced satellite openings 218, allow the knob body to resiliently flex when mounted or secured to a shaft, thereby stretching the inner diameter of opening 106 to accommodate the shaft diameter. Resilient flexure of the material of knob body 102 generally, and of material between central opening 106 and satellite openings 218, enables knob body 102 to squeeze or grip a shaft to which it is mounted or secured, and in a manner sufficient to prevent undesired rotation of knob body 102 relative to the shaft under normal use, while still flexibly accommodating a wide range of shaft diameters.

When suitable materials having a high resiliency are selected for knob body 102, the risk of material splitting may increase when larger shaft diameters are pressed into central opening 106. Accordingly, by providing circumferentially spaced satellite openings 218 as through-holes surrounding central opening 106, voids 230 (as shown with reference to FIG. 8) in the resilient material of knob body 102 more flexibly facilitate radial squeezing or compression of the inside of knob body 102 to accommodate varying shaft diameters and without potentially splitting the resilient material itself. Further, the resilient material and internal structures of knob body 102 including satellite openings 2018, enable a reversible securement to a shaft, thus with moderate force the knob body 102 may be removed from the shaft by a user's fingers, for example.

In the case of standard effects pedals and musical devices, standard shaft diameters can range from about 6.0 mm for split shafts, to about 6.4 mm for solid shafts, for example, whereas the inner diameter of the central portion 108 of knob body 102 may be between about 5.0 mm to about 5.8 mm when unmounted.

Knob body 102 can be formed of a resilient material such as a natural or synthetic rubber, rubber-like materials, or of any other suitable material having an appropriate hardness for flexibly accommodating yet securely attaching to a variety of shaft diameters and types as previously described. One example of a suitable material is styrene-butadiene rubber (SBR), which has good resiliency and high durability over repeated use. Suitable hardness for the resilient material may be from about 60 to about 80 durometer as measured by ShoreA, more preferably about 70. In selecting the appropriate material, knob body 102 should grip the shaft tightly enough with sufficient mutual friction such that knob body 102 will not slip rotationally relative to the shaft when subject to normal operating conditions that create nominal magnitudes of torque applied by a user. Further, as described previously, by providing compressible satellite openings 218 having voids 230 through knob body 102, a wider range of resilient materials may be suitably used without risk of material failure or splitting on larger shaft diameters.

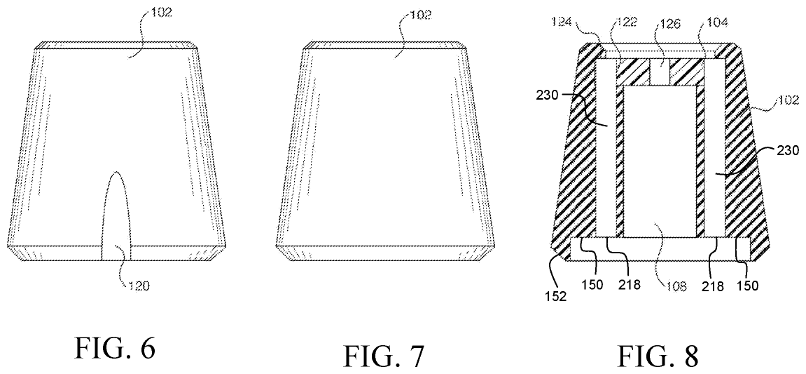

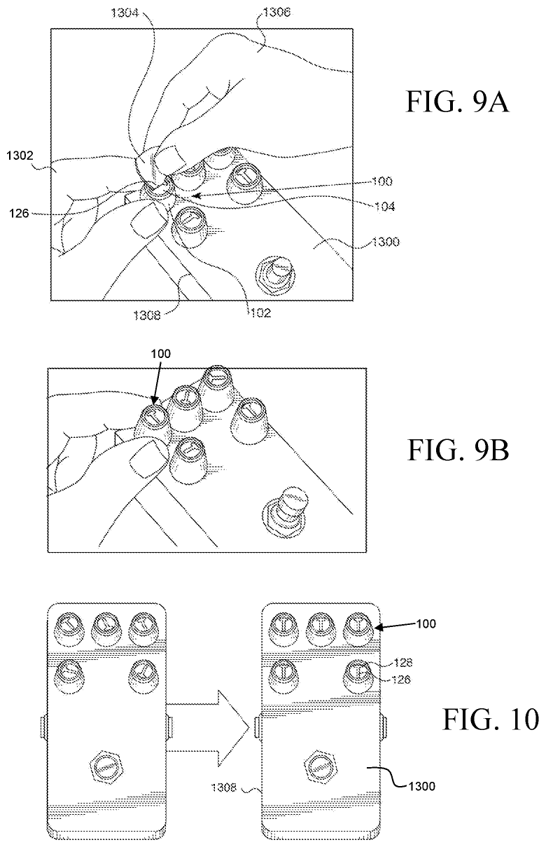

FIGS. 6 and 7 are schematic elevation views of different sides of knob 102. As shown, the outside diameter of knob 102 tapers from bottom to top, such that the diameter of the bottom or first end is larger than the diameter of the top or second end, forming a conical shaped geometry. This tapered or conical shaped geometry minimizes obstructions to the user's view, allowing better viewing angles to see any device indicators or markings adjacent to the knobs when attached. Further, this geometry enables a user to more easily grip the base of knob body 102 with their fingers to rotationally constrain it while applying torque to marker disk 104, as further described with reference to FIG. 9.

It may be appreciated that any suitable diameter of the knob body 102 may be used according to the needs of the application and characteristics of the device. In the field of musical effects, suitable diameters for the base of knob body 102 may be from about 11 mm to about 16 mm, for example, or more preferably, about 15 mm. At about 15 mm, the base of the device is unlikely to obscure any of the markings adjacent to the knobs of standard musical effects devices, while still providing suitable functionality of the knob 100, including a sufficient amount of resilient material to accommodate various shaft sizes.

Knob body 102 can include a position indicator mark 120, that can help a user recognize the rotational position of knob 120 (and the corresponding setting of the control associated with the knob). As described previously, friction fixes the rotational position of knob 102 with respect to its associated shaft, thus position indicator mark 120 provides an absolute indication of the rotational position of knob 120 and a shaft to which it is attached. Position indicator mark 120 may comprise any kind of marker, including a painted or otherwise drawn indication, however, more suitably comprises a physical notch in the material of the knob body 102 itself, which cannot fade or be rubbed off by repeated use. Further, a physical notch allows for a user to more easily feel and recognize the position indicator mark 120 under their fingers when rotating knob 100.

Further, the knobs of the present disclosure provide efficient and user-friendly methods to store, record or recognize the rotational position of a knob or plurality of knobs at any desired setting or combination of settings, as well as to easily and efficiently restore the knob or plurality of knobs back to their desired settings after continued or further adjustment of the knobs during use.

As described herein, knob 100 is configured to receive a marker disk 104 at a top portion or second end of the knob body 102. An assembled knob 100 can include marker disk 104 nested in knob body 102 as depicted in the Figures. The nesting of marker disk 104 in knob body 102 can in some aspects be appreciated with reference to FIG. 8, which is a cross-sectional view of knob 102 along section A-A of FIG. 4. Knob body 102 can define or include a receptacle 122 at a top portion or second end that can be structured and configured to securely receive marker disk 104 such that marker disk 104 can be rotated relative to the knob body, but only when external force, such as torque, is applied to it. Knob body 102 can include an undercut or lip 124 substantially around a perimeter of receptacle 122 for stable retention of marker disk 104 during use of knob 100.

The shape and structure of receptacle 122 and the resilience of the material of knob body 102 can be such that marker disk 104 can readily be pressed manually by fingertip in to the receptacle 122, whereas once the knob 100 is so assembled, the marker disk will be stably retained in receptacle 122 (for example, by lip 124) in the absence of a deliberate effort to remove it. Accordingly, assembly efficiency as well as repair efficiency is improved by the design of knob 100 allowing for a press fit marker disk that does not require any separate attachments means, such as screws, etc.

Marker disk 104 can define or include a slot shaped opening 126, shaped to receive a guitar pick tip, coin, ID or credit card corner, or similarly shaped object that would be readily available to the user of knob 100. Slot shaped opening 126 is depicted in the Figures as a through-slot, although this is not limiting and other configurations are possible. However, a through-slot may facilitate efficient manufacturing of slot shaped opening 126 when using a metal stamping production method, for example.

In an example of a musician user, a guitar pick engaged with slot 126 can be used to externally apply torque to marker disk 104 as described below with reference to FIGS. 9A and 9B, which schematically illustrates, in part, hands of a musician engaging with knob 100 installed on device 1300, such as an effects pedal. As illustrated, device 1300 can include several other knobs, which can be identical or similar in design to knob 100.

In some embodiments, marker disks may include slots 126 or other structures configured to receive torque or be driven from an adjustment tool or tools other than, or in addition to, commonly accessible objects. For example, marker disks can include openings or voids to be driven by flat, Phillips, hex, Torx, or any other suitable screw or rotational drive known in the art. In other examples, a proprietary drive mechanism may be used to apply torque to marker disks. Further, knobs of the present disclosure may be provided with a tool specifically designed and configured for marker disk torqueing. However, in the field of musical devices, an advantage of marker disk 104 with slot 126 being shaped to receive a guitar pick for application of torque is that guitarists generally would be expected to have guitar picks close at hand, obviating the need for any special tools. Similarly, for non-musical devices, slot shaped opening 126 may be configured to receive common household or other objects readily available to an average user, such as coins, standard keys on a keychain, a corner of a credit or ID card, etc.

Marker disk 104 can be formed of any suitable material capable of receiving external torque applied to it without cracking or failure, and while also being rigid enough to enable press-fit or other insertion into knob body 102. Suitable examples include but are not limited to plastic or other polymers of any suitable hardness; a metal, such as, but not limited to, aluminum or steel; a natural material, such as, but not limited to, wood, bone, or shark's tooth; etc.

FIGS. 9A and 9B show one example of knob 100 being used on a device 1300 such as a guitar effects pedal, but as described herein, is not intended to limit the potential use of knob 100 to this field. Knob 100 may be suitably used for any device presenting an adjustment shaft on its surface, such as common potentiometers or pots. In the non-limiting example of FIGS. 9A and 9B, a musician user of knob 100 is shown gripping the first knob body 102 on the device 1300 with fingers of a first hand 1302, and manipulating guitar pick 1304 with fingers of a second hand 1306. Guitar pick 1304 can be engaged with slot shaped opening 126 of marker disk 104. By such manipulations, an external source of torque can be applied to marker disk 104 and the disk can be rotated relative to knob body 102 to a new reference orientation shown in FIG. 9B, while fingers 1302 rotationally constrain knob body 102, thereby storing the desired position of knob 100 via orientation of marker disk 104. As shown in FIG. 9B, the chosen reference orientation of marker disk 104 is the 12 o′clock position for the first knob 100 of device 1300. Knob 100 can be designed, constructed, and assembled such that friction between the marker disk 104 and the knob body 102 allows marker disk 104 to be rotated relative to knob body 102 via external torque applied to marker disk 104, such as by guitar pick 1304, when knob body 102 is rotationally constrained, such as by fingers of first hand 1302. Further, friction between marker disk 104 and knob body 102 can prevent rotation of marker disk 104 relative to knob body 102 when the knob body is rotated in the absence of external torque applied to the marker disk. Thus, for example in the case of a musical device 1300, marker disk 104 can easily be rotated relative to knob body 102 by twisting guitar pick 1304 or a similarly shaped item engaged with slot shaped opening 126, but otherwise, if not tampered with, will stably maintain its orientation relative to knob body 102 during normal rotational adjustment and use of knob body 102.

As an example of a method of using knob 100, and in reference to FIGS. 9A, 9B and 10, a user can experiment by rotating any or all knobs of device 1300, such as a guitar effects pedal, until finding a combination of desired knob settings to the user's liking. The user can then rotate the marker disk 104 of each knob 100 one-by-one by holding the knob body 102 firmly (such as with left hand 1302 as illustrated in FIGS. 9A and 9B) so that the knob body 102 is rotationally constrained, and then using a guitar pick or similarly shaped suitable object, can rotate each marker disk 104 to a common reference orientation (such as with right hand 1306 as illustrated in FIG. 9A). A suitable common reference orientation can be, for example, with the marker disk slot(s) 126 aligned with edge 1308 of device 1300, as shown in the righthand image of FIG. 10, or a user determined orientation relative to some other feature of device 1300. When all knobs 100 have had their marker disks 104 rotated to the common reference orientation, the user, having marked a first preferred combination of knob 100 settings, can then enjoy the freedom of further knob-adjusting and experimentation, secure in the knowledge that the first preferred combination of knob 100 settings can easily be restored if further experimentation is not fruitful. If it is desired, after such further experimentation, to restore or return to the first preferred combination of knob 100 settings, the user can efficiently rotate each knob 100 such that the marker disk slot 126 of each knob 100 is returned to alignment with the common reference orientation chosen by the user as represented in FIG. 10. This reference orientation may be freely determined by the user depending on what is easiest for the user to remember or recognize, such as having slots 126 aligned with an edge 1308 of the device 1300, aligned with a 12 o′clock position, or other common reference orientation corresponding to an original desired position of the knobs.

To eliminate possible confusion about the rotational orientation of marker disk 104 due to symmetry of slots 126, the marker disk 104 can include an orientation indicator 128, as shown with reference to FIGS. 1, 2, 9A, 9B and 10. In the example described by these

Figures, disk orientation indicator 128 is shown comprising a lateral or generally T-shaped junction at one end of the slot. An advantage of such feature is that it facilitates a single-step stamping out of disk material to form slot shaped opening 126 integrated with indicator 128, thus is an efficient design from a manufacturing standpoint. Further, in this example, disk orientation indicator 128 is thus a permanent physical feature of the disk material itself and cannot fade or rub off like a painted marker. Nonetheless, it may be appreciated that any suitable symmetry-breaking marking can be used as an orientation marker 128, such as an arrowhead, alphanumeric character, glyph, etc, whether painted or otherwise marked on a surface of marker disk 104, or whether stamped into the material of marker disk 104 separate from or integrated with slot 126.

While the invention has been described with reference to an exemplary examples and embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) and examples herein disclosed, but that the invention will include all embodiments falling within the scope of the appended claims.

1. An adjustment knob, comprising:
a marker disk comprising a disk material and a slot shaped opening; and
a knob body comprising a resilient material, the knob body having a first end and a second end, the first end configured to reversibly secure the knob to an adjustment shaft, the second end having a receptacle configured to securely receive the marker disk such that the marker disk can be rotated relative to the knob body.

2. The knob of claim 1,
wherein the marker disk is retained by the knob body by an interference fit; and
wherein friction between the marker disk and the knob body allows the marker disk to be rotated relative to the knob body via external torque applied to the marker disk when the knob body is rotationally constrained.

3. The knob of claim 2, wherein the friction between the marker disk and the knob body prevents rotation of the marker disk relative to the knob body when the knob body is rotated in the absence of external torque applied to the marker disk.

4. The knob of claim 1, wherein the knob body comprises a knob position indicator and the marker disk comprises a disk orientation indicator.

5. The knob of claim 4, wherein the knob position indicator comprises a notch in the resilient material.

6. The knob of claim 4, wherein the disk position indicator comprises a lateral or T-shaped junction at one end of the slot.

7. The knob of claim 1, wherein the knob body comprises a central opening for receiving the adjustment shaft, and a plurality of satellite openings circumferentially spaced around the central opening for flexibly facilitating securement of the knob body to various shaft diameters.

8. The knob of claim 7, wherein the central opening and plurality of satellite openings comprise through-holes extending from the first end to the second end of the knob body.

9. The knob of claim 8, wherein the central opening has a diameter of between about 5.0 mm to about 5.8 mm.

10. The knob of claim 9, wherein the adjustment shaft comprises a split shaft or a solid shaft.

11. The knob of claim 1, wherein the knob body comprises a tapered geometry extending between the first end and the second end, and wherein the diameter of the first end is larger than the diameter of the second end.

12. The knob of claim 1, wherein the slot shaped opening is configured to receive a guitar pick, coin, key, card corner, or similarly shaped object.

13. The knob of claim 1, wherein the resilient material comprises a synthetic rubber.

14. The knob of claim 13, wherein the synthetic rubber comprises styrene-butadiene.

15. The knob of claim 1, wherein the resilient material has a ShoreA durometer hardness of about 60 to about 80.

16. The knob of claim 1, wherein the diameter of the first end is between about 11 mm to about 16 mm.

17. The knob of claim 1, wherein the disk material comprises a plastic polymer or metal.

18. A method for using the knob of claim 1, comprising:
rotating the knob to a desired position on a device; and
applying external torque to the marker disk to rotate it relative to the knob body to store the desired position via an orientation of the marker disk.

19. The method of claim 18, wherein external torque is applied to the marker disk via insertion of an object into the slot and twisting while rotationally constraining the knob body.

20. A method of using the knob of claim 1, comprising:
rotating a plurality of knobs on a device, each to a separate original desired position;
applying external torque to the marker disk of each of the plurality of knobs to rotate each marker disk relative to each knob body to store the original desired position of each knob via a common reference orientation of the marker disks;
further rotating the plurality of knobs each to a new desired position; and
restoring each of the plurality of knobs back to their original desired positions by rotating each knob until each marker disk returns to the common reference orientation.
